(19) United States
(12) Patent Application Publication
(10) Pub. No.: US 2003/0056891 A1
(43) Pub. Date: Mar. 27, 2003

(54) Adhesive security tape for indicating unauthorized attempts at opening dispatch packages

(76) Inventors: Andreas Schroder, Hamburg (DE); Ulrich Otten, Hamburg (DE)

Correspondence Address: KURT BRISCOE, NORRIS, MCLAUGHLIN & MARCUS, P.A., 220 EAST 42ND STREET, 30TH FLOOR, NEW YORK, NY, 10017, US

(21) Appl. No.: 10/247,409

(22) Filed: Sep. 19, 2002

(30) Foreign Application Priority Data
Sep. 19, 2001 (DE) 101 46 270.0

(51) Int. Cl. B32B 31/00

(52) U.S. Cl. 156/234; 156/230; 156/240; 156/277; 156/289

(57) ABSTRACT

The use of a multilayer adhesive tape having a backing based on an oriented thermoplastic film, an upper surface and a lower surface, to whose lower surface at least the following layers have been applied:

a) a primer layer which is not applied over the full area and which anchors very well to the thermoplastic film,

b) a release layer which is applied over the full area of the applied primer layer and the free thermoplastic film surface, the release layer anchoring better to the primer layer than to the thermoplastic film,

c) a pressure-sensitive adhesive composition which is applied over the full area of the release layer and which is anchored better on the release layer than the release layer is on the thermoplastic film.

for sealing dispatch packages including pouches, envelopes, packets and bags.

The invention relates to the use of a multilayer adhesive tape based on an oriented thermoplastic film coated on one side with adhesive for sealing dispatch packages with the aim of indicating any unauthorized attempts at opening.

Preferred dispatch packages in the context of use in accordance with the invention include pouches, envelopes, packets, bags and the like, referred to collectively below as transit packets without any intention to restrict said use to packets in particular.

Through the use of the adhesive tape the attempt at opening the dispatch package is indicated by virtue of the fact that regions of the adhesive tape, when the latter is peeled from the surface to which is it adhered, remain on said surface as a message, said message being invisible prior to detachment from the surface. The message remains visible even if the adhesive tape, having been partly detached, is replaced exactly on the original bonding position.

Protecting goods in transit in the logistical chain from producer to user has become more difficult owing to the large number of links in this chain. Accordingly, the costs occasioned by theft of the product from its dispatch packaging in the course of warehousing or transit have become a significant factor. The recipient of a dispatch package in which some of the product has been switched or removed by theft, moreover, has difficulties in proving that this act was not committed within his or her own sphere of influence.

One link in this chain is formed by freight companies or courier services which take on the task of transport to the recipient. The sending of goods of high intrinsic value which are small in size, or documents, is normally effected in dispatch package, which are frequently sealed in the region of their opening using normal adhesive systems. These adhesive systems can often be opened with simple tools such as knife blade without the attempt at manipulation being evident.

Significantly greater security against attempted theft, and reliable detection of the fact that a dispatch package has been opened prior to transfer to the next section of the logistics chain is made possible by an adhesive tape that indicates, by means of an irreversible message, that it has already been detached once from the surface of the dispatch package.

Security systems for detecting unauthorized opening are known and are described in multiplicity in the prior art. Security labels, in particular, are of great importance in this context. For example, U.S. Pat. No. 4,184,701 describes security labels which are constructed from a plurality of color layers or, generally layers and which as a result exhibit little adhesion of the product layers to one another. In combination with a strongly adhering adhesive, such layers separate from one another irreversibly, thereby indicating the opening of the package.

Furthermore, for example, DE 34 31 239 A1 describes the use of security labels composed of a backing material possessing low tear propagation resistance. In combination with a strongly adhering adhesive, the security label is irreversibly destroyed on removal and thus indicates the attempt at opening.

The security label has a lower, first adhesive layer, intended for detachment from a backing and application to the package, on the bottom face of a first label material to whose top face there is applied, by means of a second adhesive layer, a second label material. The extent of the bond strength of the first adhesive layer between the package and the first label material is different than the extent of the bond strength of the second adhesive layer between the first label material and the second label material.

Adhesive security tapes are commonly designed in such a way that a weakness in anchoring below the colored structure of the adhesive tape is introduced in the region of the writing. For instance, U.S. Pat. No. 5,633,058 describes a transparent printed indicium, anchored weakly to the backing film, which is covered with a full-area colored layer which anchors well to the backing film and to the first indicium. The colored layer is covered with a self-adhesive composition. When an adhesive security tape of this kind is peeled from a surface, the transparent printed indicium is parted from the film surface, together with the color layer and the adhesive, and remains as writing on the surface.

EP 0 491 099 A1 describes a printed indicium composed of a silicone material which is likewise covered with a colored layer which adheres well to the film. The colored layer is covered with a self-adhesive composition. When an adhesive security tape of this kind is peeled from a surface, the color layer and the adhesive detach from the silicone surface and remain as writing on the surface.

The disadvantage of a construction of this kind is the complex process engineering for producing the layers, since partial silicone surfaces greatly hinder further coating, owing to the low surface tension.

U.S. Pat. No. 4,121,003 describes how the transfer of writing is brought about by this writing being composed of a material of low cohesion which, when the adhesive security tape is detached, splits within itself and remains in part on the surface to which it was adhered.

EP 0 404 402 A2 is based on a transparent splittable layer which becomes opaque at the boundary layer which forms, and which therefore offers, in relation to hitherto invisible writing, an optical contrast surface against which the writing then becomes legible.

For addressing the problem of manipulation-secure sealing of dispatch packets, diverse solutions are likewise known.

U.S. Pat. No. 4,838,708, for example, proposes a security bag whose opening is equipped with an adhesive system. The adhesive system is implemented such that, as a result of two different bond strengths of two adhesives to the bag material, writing is produced. Also specified therein are embodiments on the same basis which likewise envisage an adhesive strip for sealing the bag.

A security system for bags which displays a visual indication, inter alia, when the temperature falls below a predetermined level is described in U.S. Pat. No. 5,631,068. The adhesive tape in this case is composed of a flexible film of polyethylene coated with adhesive and a color layer in the form of a printed image. By means of an appropriate combination of backing and adhesive in terms of different thermal expansion and/or shrinkage coefficients, the color layer undergoes delamination on cooling or heating above/below a certain temperature.

Another embodiment of a guarantee closure for a dispatch pouch is specified in EP 0 460 459. The closing flap of the dispatch pouch is coated by paper deposition with a metal layer a few micrometers thick, is coated with an adhesive, and is provided with a protective covering which can be removed prior to use. In the case of an attempted opening, the metal layer suffers irreversible damage and thus indicates the attempt at manipulation. A further embodiment specified here is composed of the same layer structure of metal layer and adhesive on a polyester film as the adhesive tape.

A solvent-resistant security closure for bags is indicated in GB 2 138 396. Closure of the bag here is effected by means of an adhesive strip whose adhesive undergoes a change in color on contact with a solvent. To this end, the adhesive of the strip contains a dye formulation which is soluble in solvents that attack the adhesive.

One important requirement for security against manipulation is the rapidly and readily visible individuality of the adhesive tape closure. Normal adhesive packaging tapes are therefore printed with the individual company logo on the reverse of the backing, so that replacement by or oversticking with a different adhesive tape can easily be recognized. The minimum possible print run for adhesive tapes marked in this way is a single roll, thus making it possible to achieve great individuality of the supply of the packages which are sealed using this adhesive tape.

These two security effects—message transfer and individualized printing—have not to date been satisfactorily combined. Subsequent printing on the reverse of the backing of existing adhesive tapes is not possible by means of customary printing processes, owing to the necessary silicone release system on that surface. In the case of existing embodiments of such an adhesive tape, therefore, the backing film is printed before being coated with the layers needed for the message transfer effect. A consequence of this is that only large runs of adhesive tape with an individual print can be economically produced.

Available versions of an adhesive security tape of the type described are printed by way of substitution with a serial number, in order to achieve individualization. This method, however, necessitates a high level of information exchange within the logistics chain. Moreover, labor-intensive checking of each dispatch unit for matching with the circle of numbers announced by the producer is necessary.

The technical implementation of an adhesive security tape of this kind is very costly in terms both of material and of the production process. To date, therefore, backing films have been used which are composed of expensive materials such as polyester and polystyrene. Films based on polystyrene, however, are brittle and do not withstand the impact loads and propping loads which arise during transit and during the warehousing of packages sealed with adhesive packaging tapes.

Thermoplastic films based on polyethylene terephthalate (PET) or polyvinyl chloride (PVC) are used by various manufacturers for the purpose of producing adhesive tapes. In this context, PET-based films in particular are distinguished by high elongation at break, thermal stability from 130° C. to 175° C., and resistance to dilute alkalis and acids.

Moreover, polyester-based films possess a very high abrasion resistance and penetration resistance but are less widespread in the adhesive packaging tapes sector than polyolefin-based films, owing to the relatively high price.

Films based on PVC are offered in combination with solventborne adhesives based on natural rubber by a number of manufacturers as adhesive packaging tapes. Owing to the better thermal stability, films of unplasticized PVC are used, which possess good thermal stability up to a maximum of 105° C.

The PVC may be obtained by emulsion, suspension or bulk polymerization. Additionally, copolymers based on PVC/vinyl acetate are known.

Furthermore, the films based on unplasticized PVC are notable for moderate puncture strength and partial resistance to gasoline, oil, and alcohols. In general, in the absence of corona treatment, the anchoring of primers to PVC films is better than in the case of other thermoplastic films, such as polyolefin-based films, for example. This is a result of the high surface energy even without pretreatment [approximately 39 dyn/cm] and of the rough surface texture of PVC films. For adequate anchoring of adhesives based on natural rubber, a primer-coated PVC film is advisable.

In the production of adhesive tapes for adhesives based on natural rubber, both water-based and solventborne primers are used as adhesion promoters between adhesive and backing film. These adhesion promoters which are used possess in part a crosslinking effect on the adhesive based on natural rubber, which is applied from solution.

It is an object of the present invention to specify the use of an adhesive security tape which on removal from the surface of a package, particularly the surface of a dispatch packet or the like, leaves behind a layer, especially a colored layer, within which there is inverted writing. At the same time, the identical writing is visible in positive form on the peeled-off film backing.

This object is achieved by the use of an adhesive tape as specified in the main claim. The subclaims relate to advantageous developments of the subject matter of the invention. The invention further relates to other proposed uses of the adhesive tape of the invention.

The invention accordingly provides for the use of a multilayer adhesive tape having a backing based on an oriented thermoplastic film, an upper surface, and a lower surface, to whose lower surface the following layers have been applied:

a primer layer which is not applied over the full area and which anchors very well to the thermoplastic film,

a release layer which is applied over the full area of the applied primer layer and the free thermoplastic film surface, the release layer anchoring better to the primer layer than to the thermoplastic film,

a pressure-sensitive adhesive composition which is applied over the full area of the release layer and which is anchored better on the release layer than the release layer on the thermoplastic film

for sealing dispatch bags, pouches, envelopes, packets, and the like.

The term “adhesive tape” as used here is not intended to comprehend any particular restrictions with regard to areal extent, so that adhesive sheets and the like are also in accordance with the subject matter of the invention.

The use of an adhesive tape of this kind serves, for example, to indicate an unauthorized attempt at opening.

When the adhesive tape of the invention is removed from the surface of a package, especially a dispatch packet or the like, it leaves inverted writing on the package, by virtue of the fact that the first, especially colored release layer separates from the thermoplastic film, while areas which have been anchored to the backing surface firmly by means of primer are detached from the package surface together with the backing.

The region of the first release layer which was strongly anchored to the film surface by the primer layer remains on the backing surface.

An appropriate gradation of the release forces of the multilayer construction produces reliable separation within the adhesive tape, and the splitting of the package surface, especially in the case of cardboard packaging, dispatch packets made from sodium kraft paper, or paper packets, is prevented by the adhesive composition. The writing may be reliably transferred, in particular, to all standard commercial paper grades or materials for dispatch packets or the like, which may be composed, for example, of printed polyethylene.

The message is invisible prior to the detachment of the adhesive tape from the surface. Following detachment, the message remains visible even if the adhesive tape is replaced exactly in the original bond site, so that the evidence of a manipulation of quantitative or qualitative nature remains visible on the packaged product.

The use of the adhesive security tape ensures that the message is transferred reliably to

a) solid surfaces which are difficult to split,

b) surfaces with little splitting resistance, and

c) surfaces having antiadhesive properties, as are customary in the case of standard commercial paper grades from waste paper.

Furthermore, the concept of the invention embraces the use of adhesive security tapes as specified in the claims for which economic individual printing for a minimum of one roll is possible.

It is advantageous to use an adhesive tape wherein the thermoplastic film is composed of oriented polyolefins or of polyester and in particular is transparent.

Preferably, the thermoplastic film is composed of oriented HDPE, PVC, PET, monoaxially oriented polypropylene, or biaxially oriented polypropylene.

Polyester-based films, polyethylene terephthalate for example, may likewise be used to produce the adhesive tapes of the invention. The thicknesses of the films based on PET are between 20 and 100 μm, in particular between 30 and 50 μm.

Films based on oriented polyolefins belong to the prior art. Monoaxially and biaxially oriented films based on polyolefins are used in large amounts for adhesive packaging tapes, strapping tapes, and other adhesive tapes. Also known are films based on oriented polyethylene or oriented copolymers containing ethylene and/or propylene units. All of these listed films may be used as the backing film in accordance with the invention.

Monoaxially oriented polypropylene is notable for its very high tensile strength and low stretching in the longitudinal direction and is used, for example, to produce strapping tapes. For producing the adhesive tapes of the invention for the bundling and palletization of cardboard boxes and other goods, preference is given to monoaxially oriented films based on polypropylene.

The thicknesses of the monoaxially oriented films based on polypropylene are preferably between 25 and 200 μm, in particular between 40 and 130 μm.

Films of monoaxially oriented polypropylene are particularly suitable for producing the adhesive tapes of the invention. Monoaxially oriented films are predominantly single-layer films, although in principle multilayer monoaxially oriented films may also be produced. The known films are predominantly one-, two- and three-layer films, although the number of layers chosen may also be greater.

For use in accordance with the invention for secure sealing of dispatch packages and the like, preference is given to adhesive tapes comprising biaxially oriented films based on polypropylene with a draw ratio in the longitudinal (machine) direction of between 1:4 and 1:9, preferably between 1:4.8 and 1:6, and a draw ratio in the transverse (cross) direction of between 1:4 and 1:9, preferably between 1:4.8 and 1:8.5.

The moduli of elasticity achieved in the longitudinal direction, measured at 10% elongation in accordance with ASTM D882, are usually between 1000 and 4000 N/mm², preferably between 1500 and 3000 N/mm².

The thicknesses of the biaxially oriented films based on polypropylene are in particular between 15 and 100 μm, preferably between 20 and 50 μm.

Biaxially oriented films based on polypropylene may be produced by means of blown film extrusion or by means of customary flat film units. Biaxially oriented films are produced both with one layer and with a plurality of layers. In the case of the multilayer films, the thickness and composition of the different layers may also be the same, although different thicknesses and compositions are known.

Particularly preferred for use in accordance with the invention are adhesive tapes comprising single-layer, biaxially or monoaxially oriented films and multilayer, biaxial or monoaxial films based on polypropylene which have a sufficiently firm bond between the layers, since delamination of the layers in the course of the application is disadvantageous.

Films based on unplasticized PVC are likewise known and are used by various adhesive tape manufacturers to produce adhesive packaging tapes. Plasticized PVC films are likewise suitable for producing adhesive packaging tapes, although their inadequate heat resistance of max. 60° C. must be taken into account.

For the inventive use of adhesive tapes for secure sealing of a dispatch package or the like it is preferred to use adhesive tapes comprising films based on unplasticized PVC. The thicknesses of the films are preferably between 30 and 100 μm, in particular between 35 and 50 μm. Use in accordance with the invention envisages the sealing of pouches, envelopes, packets, bags and the like.

Advantageously, use is made of adhesive tapes wherein the upper surface of the thermoplastic film has been coated with a release coating. Release coatings as may be applied to the upper film surface, i.e., to the film surface opposite the adhesive composition, are in widespread use in the adhesive tape industry. An overview of release coating systems based on silicone and their use in the pressure-sensitive adhesives field may be found in “Silicone Release Coating” (D. Jones, Y. A. Peters in Handbook of Pressure Sensitive Adhesive Technology, Third Edition, edited by Donatas Satas, Van Nostrand Reinhold New York, pp. 652-683).

The use of rear-face release coatings results in easy, uniform unwinding of the adhesive tapes. Used above all in this context are release coatings based on solventborne carbamate systems and on silicone-based systems.

Release coatings based on silicone systems are suitable as release coatings of the adhesive tapes of the invention. Preferred release coatings are UV-curing silicone systems on a 100% basis, although solventborne silicone systems may likewise be used as a release coating for the adhesive tapes of the invention.

The application rate of the release coating on the backing material is preferably from 0.1 to 3 g/m². In a further, particularly preferred embodiment, the application rate of the release coating layer is set at from 0.2 to 1.5 g/m².

In order to achieve very good anchoring of the first release layer during use of the adhesive tape in accordance with the invention on specific regions of the film, an adhesion promoter or primer is used as the first layer. In this case, the film surface opposite the release coating (lower surface) is used.

Both solvent- and water-based adhesion promoters are used as adhesion promoters between film and adhesive composition or further layers for the production of adhesive tapes. Layers with high affinity to backings or adhesion to backings based on thermoplastic films are used to produce adhesive tapes. The high affinity to surfaces of backings based on thermoplastic films governs the quality of such components for use as appropriate adhesion promoters. A variety of primer systems are known. Adhesion promoters suitable for use as the first release layer of the adhesive tapes of the invention are, for example, aqueous adhesion promoters based on polyurethanes, polypropylenes with low degrees of chlorination, styrene-butadiene copolymers, and acrylates. Solventborne adhesion promoters are likewise suitable for the anchoring of subsequent layers in the adhesive tapes of the invention. Within the adhesives tape industry, these adhesion promoters are used as primers.

The application rate of the primer layer to the backing material is preferably from 0.5 to 12 g/m². In a further preferred embodiment, the layer application rate of the first adhesion promoter layer is set at from 1.5 to 6 g/m².

In one preferred embodiment of the adhesive tape used in accordance with the invention, the adhesion of the primer layer to the polyolefin-based thermoplastic film is improved by means of corona treatment or, especially, by means of flame pretreatment, since the surfaces of films based on oriented polyolefins in particular may be treated by means of these widely known processes, such as corona treatment or flame treatment. Preference is given to surface treatments by means of flame pretreatment. An overview of the techniques for surface treatment is contained, for example, in the article “Surface pretreatment of plastics for adhesive bonding” (A. Kruse; G. Krüger, A. Baalmann and O. D. Hennemann; J. Adhesion Sci. Technol., Vol. 9, No 12, pp. 1611-1621 (1995)).

The primer layer is not applied over the whole area of the thermoplastic film-based backing surface opposite the release coating. In order to achieve a visual security effect in the inventive use of the adhesive tapes, the primer layer is applied in a specific, non-blanket manner to the film surface. The application of the primer layer is designed in such a way that only specific regions of the film surface are coated and these coated regions form, for example, the word “OPENED” or “VOID”. This mode of application of the primer layer is made possible by means of appropriate printing processes.

The non-fully applied primer layer on the film surface preferably constitutes characteristic signs or symbols, especially in the form of letters or words.

A release layer is applied over the full area of the primer layer or to the free surface regions of the film used, for the production of the adhesive tapes used in accordance with the invention. Examples of suitable release layers for the adhesive tapes of the invention are resin dispersions, acrylate dispersions or, in general, polymer dispersions, or solventborne polymer solutions, which exhibit a brittleness and a low adhesion to the backing which is sufficient after drying.

Particularly preferred release layers for the adhesive tapes used in accordance with the invention are appropriate printing inks for backings based on thermoplastic films. For this layer, use is made, for example, of water-based, solvent-based or UV-curing flexographic inks. Ink layers of this kind are strongly colored and suitable for application to the first layer and/or the film by means of a wide variety of technologies. Through an appropriate choice of the printing inks it is possible to formulate the release layer system of the adhesive tapes used in accordance with the invention in such a way that the release layer is very well anchored to the primer layer but exhibits poor adhesion, or a poor bond, with the film regions that have not been coated with the primer layer.

The application rate of the release layer to the backing material and/or the primer layer is preferably from 2 to 18 g/m². In a further preferred embodiment, the layer application rate of the first layer is from 5 to 11 g/m².

As adhesive compositions it is possible to use essentially all known adhesive compositions with high bond strength on the adhesion substrate which is to be packaged.

The adhesive composition of the adhesive tape used in accordance with the invention may comprise an adhesive composition based on solventborne natural-rubber and acrylate adhesive compositions. Preference is given to adhesive compositions based on acrylate dispersions, especially aqueous acrylate dispersions. These adhesive composition technologies are used in the adhesive tape industry.

The application rate of the adhesive composition to the backing material is preferably from 15 to 60 g/m². In another preferred embodiment, the layer application rate is set at from 20 to 30 g/m².

The adhesive tapes used in accordance with the invention are produced in a multistage process. In a first step, one (upper surface) of the surfaces of the thermoplastic film-based backing is coated with the silicone-based release coating. This single-sided coating of the backing is realized using corresponding coating units.

The film surface opposite the release coating (lower surface) is pretreated by corona or flaming if desired.

The primer layer with high affinity for the surface of the thermoplastic film used is applied by means of flexographic printing to the film surface opposite the release coating (lower surface).

Printing by means of the flexographic process is used, inter alia, in the adhesive tape industry for the individualization of adhesive tapes.

It is carried out using printing forms whose raised parts transfer the first layer. The printing forms are flexible plates made of rubber or photopolymers. Flexographic printing components are highly mobile, both solvent-based and water-based. They dry rapidly, especially in the area of the radiation-curing systems. For the production of the adhesive tapes of the invention, it is preferred to use aqueous flexographic printing components. The selection of the screen roller is guided by the printing material used and by the associated flexographic printing component.

For the production of the adhesive tapes of the invention, the application of the release layer to the primer layer and/or to the open areas on the film surface is achieved by the use of customary methods. Mention may be made in this context of the application of aqueous systems by means of knife coaters or of solventborne systems by means of bar coaters, screen rollers or printing processes.

For the subsequent application of the adhesive composition to the release layer, both the bar coater and the knife coating technology are suitable.

Also possible is the application of adhesive composition based on styrene-isoprene-styrene as hot-melt pressure-sensitive adhesive to the release layer by means of known technology, in the context of the production of the adhesive tapes used in accordance with the invention.

One advantageous variant of the inventive use envisages the adhesive tape being individualized, preferably by printing with standard inks, particularly on the adhesive side.

For the use in accordance with invention, namely the manipulation-secure sealing of dispatch packets, pouches, bags, envelopes, and the like, the adhesive tape used in accordance with the invention may carry a suitable release liner on the open adhesive, in order to prevent premature or unintended automatic sealing of the dispatch packet and to allow sealing of the package only where its dispatch is intended.

The inventive concept for the use of an adhesive tape for sealing dispatch packages and the like envisages in particular specifying on the one hand an adhesive tape which carries a release liner on the adhesive-coated side and on the other hand the provision of a release liner on the adhesive side of the adhesive tape applied to the dispatch package.

Lining the adhesive tape in web form with an appropriate release liner may take place, for example, in a laminating unit following the application and drying of the adhesive. In one variant of the inventive use of the adhesive tape, the tape possesses a release liner, applied in the manufacturing process, on the side that is covered with adhesive.

Another variant of the inventive use envisages applying the adhesive tape by means of suitable applicator equipment during the process of converting a package material to a dispatch package, wherein, in one embodiment of the adhesive tape used in accordance with the invention, one half of the adhesive tape adheres to the closure flap while the other half, covered with release liner on the adhesive side, projects beyond the edge of the closure flap and is available for sealing the bag.

The inventive concept further comprises using, for the sealing of the package, an adhesive tape which is lined over the full area of the adhesive-bearing side with a release liner. Appropriate application technology and/or adhesive tape guidance during the converting of the package material to a package allows the release liner to be lifted from the adhesive tape in the application step and reapplied in the longitudinal direction to the adhesive tape which remains after some of the adhesive tape has been adhered to the closure flap. In this case it is possible to apply the release liner in its original position to the adhesive tape that has been applied to the package, so that the release liner covers only the residual region of the adhesive side and, with the other, overlaps the reverse of the closure flap. A further possibility comprises application, offset in relation to the adhesive tape, to the adhesive tape that has already been applied to the package, so that the release liner on the one hand covers the exposed adhesive side of the adhesive tape while on the other hand projects beyond the edge of the adhesive tape which protrudes beyond the closure flap. Both cases of the residual release liner offer the advantage of providing a grip aid for the manual removal of the release liner by the dispatcher.

Moreover, one embodiment of the adhesive tape used in accordance with the invention, for the variant of the release liner applied offset in relation to the adhesive tape, is that wherein the release liner protrudes not only beyond the reverse of the closure flap but also at the edge of the adhesive tape projecting beyond the closure flap.

A further variant of the inventive use is comprised in an adhesive tape comprising coverage of the adhesive side over the full area with a release liner which is slit in the longitudinal direction. During the process of cutting the web material to the roll of adhesive tape, the release liner in this case is slit by means of a further cutting mechanism or punching mechanism.

When the adhesive tape with slit release liner is applied, one half of the release liner is lifted from the adhesive tape and removed by means of suitable offtake devices, directly before application of the tape to the closure flap. By means of precise application it is possible in this way to produce a security seal which possesses no overhanging release liner and has advantages in visual terms.

In another variant of the inventive use of an adhesive tape, a release liner lines only part of the adhesive-coated side in the longitudinal direction, for example, half the side. This embodiment of the adhesive tape comes about by taking off, for example, one half of the slit release liner immediately after the slitting operation. Advantages here arise from the simplifed process regime for the producers of dispatch packages.

In a further variant of the inventive use, an adhesive tape without a release liner is used; in this case, the converting process of the packages envisages applying release liners separately to the closure flap of the package.

The design of the release liner may be such that it is composed of a paper backing or film-based backing. It is likewise possible to use release liners with a more complex structure, based on a backing comprising, for example, polyethylene-coated paper. The appropriate release liner possesses a release coating applied at least to one side of the backing, facing the adhesive that is to be lined on the adhesive tape used in accordance with the invention. Suitable release coatings of release liners are composed of silicone systems. Preferred release coatings are UV-curing silicone systems on a 100% basis, although solventborne silicone systems may likewise be used for lining the adhesive tapes. Weights per unit area of release coatings for release liners, depending on backing material, are from 0.1 to 4 g/m². For film backings, for example, at from about 0.1 to 0.5 g/m², a lower application rate is required than for release papers, with about 0.7 up to 3.5 g/m².

### BRIEF DESCRIPTION OF THE DRAWINGS

One particularly advantageous embodiment of the adhesive tape used in accordance with the invention, and its use and function, is illustrated in more detail on the basis of the figures described below, without wishing thereby to restrict the invention unnecessarily. Of these figures,

FIG. 1 shows a sectional drawing of an adhesive tape used in accordance with the invention, in its original and bonded form, in which the layer thicknesses have been shown so as to illustrate the construction and the structure of the adhesive tape,

FIG. 2 shows the inventive use of the adhesive tape when bonded to a dispatch package,

FIG. 3 shows an enlarged section of the representation in FIG. 2 with the adhered adhesive tape,

FIG. 4 shows a representation similar to that of FIG. 3, showing the inventive use of the adhesive tape when it has been partly detached from the surface of the dispatch package,

FIG. 5 shows a sectional drawing similar to that of FIG. 1, showing the conditions of the individual layers when the adhesive tape used in accordance with the invention is first removed from the dispatch package.

FIGS. 6 and 7 show variants of the lining of the adhesive-coated side of the adhesive tape mounted on the closure flap and used in accordance with the invention.

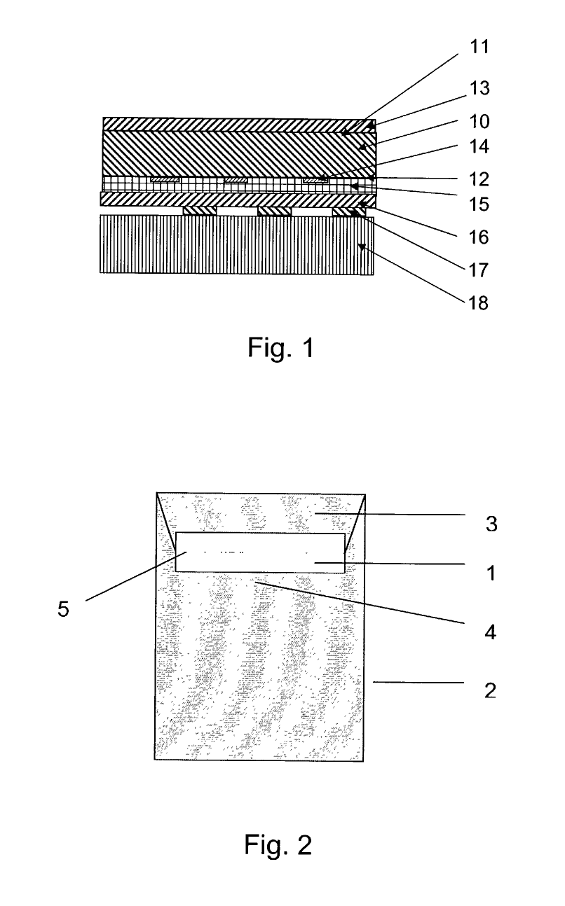

According to FIG. 1, the adhesive tape 1 is composed of a preferably transparent thermoplastic film 10 having a sufficient internal strength which ensures the utility described below. The thermoplastic film 10 has an upper surface 11 and a lower surface 12.

In a first operation, a transparent primer layer 14 is applied, but not over the full area, to the lower surface 12 of said film 10. The primer layer 14 is arranged on the lower film surface 12 in such a way that it produces writing which is visible on the dispatch package surface if the adhesive tape 1 is detached.

In a second step, a release layer 15 is applied to the primer layer 14 and the remaining lower film surface 12. The release layer 15 comprises a colored material.

The color and the color density are selected so that on the one hand they offer a sufficient color contrast to the customary dispatch package colors, so that the writing formed is legible, but so that they also allow any printing 17 of a company logo or trademark on the adhesive layer 16 to show through with good visibility.

Next, the adhesive layer 16, which ensures sufficient bonding security on the article to be sealed, is applied to the release layer 15.

The primer layer 14 adheres very strongly to the lower film surface 12. The release layer 15 adheres more weakly to the lower film surface 12 than to the primer layer 14. The adhesive layer 16 adheres more strongly to the release layer 15 than the release layer 15 to the lower film surface 12 and at least as strongly as the release layer 15 to the primer layer 14.

The adhesion of the adhesive layer 16 to a surface used in accordance with the use is greater than the adhesion of the release layer 15 to the lower film surface 12. In areas where the primer layer 14 forms part of the layer structure, the adhesion of the primer layer 14 to the lower film surface 12 and to the release layer 15 is greater than the adhesion of the adhesive layer 16 to a surface used in accordance with the use.

The adhesion of the release layer 15 to the lower film surface 12 is lower than the adhesion of the release layer 15 to the adhesive layer 16.

Applied to the upper surface 11 of the film backing 10 is a preferably transparent release layer 13 which adheres relatively strongly to the upper surface 11. The adhesion of the release layer 13 to the adhesive layer 16 is low, so that the adhesive tape 1 wound into a roll may be unwound without separation of the release layer 15 from the lower film surface 12.

In this process or in a further process, a colored printing 17 of a company logo or trademark can be applied to the outer surface of the adhesive 16.

On the outer surface of the adhesive 17 it is possible for there to have been applied, over the full area or only partially, but covering the entire width of the adhesive tape 1, a release liner 18, which is removed before use in accordance with the invention, namely the sealing of the dispatch package.

The version of the adhesive tape that is preferred for the inventive use is shown as 1 in accordance with FIG. 2, where the adhesive tape is used for securing or sealing an article such as, for example a dispatch packet 2. The packet 2 possesses a closure flap 3 and also a packet surface 4. For sealing the dispatch packet 2 the closure flap 3 is folded down onto the line 5. The adhesive tape 1 is bonded both on the closure flap 3 and on the packet surface 4.

In order to gain access to the contents of the dispatch packet 2 without the opening attempt being noticed subsequently, it is necessary to remove the adhesive tape 1 in the region of the line 5 in order to be able to fold up the closure flap 3. If the adhesive tape 1 used is a standard commercial adhesive tape, it is impossible to ascertain, after having removed the contents from the closure flap 2 and carefully restuck the adhesive tape 1, that the adhesive tape 1 has already been detached once beforehand.

Where, however, an adhesive tape 1 is used in accordance with the invention for sealing the dispatch packet, unnoticed opening and closing in the manner described is impossible.

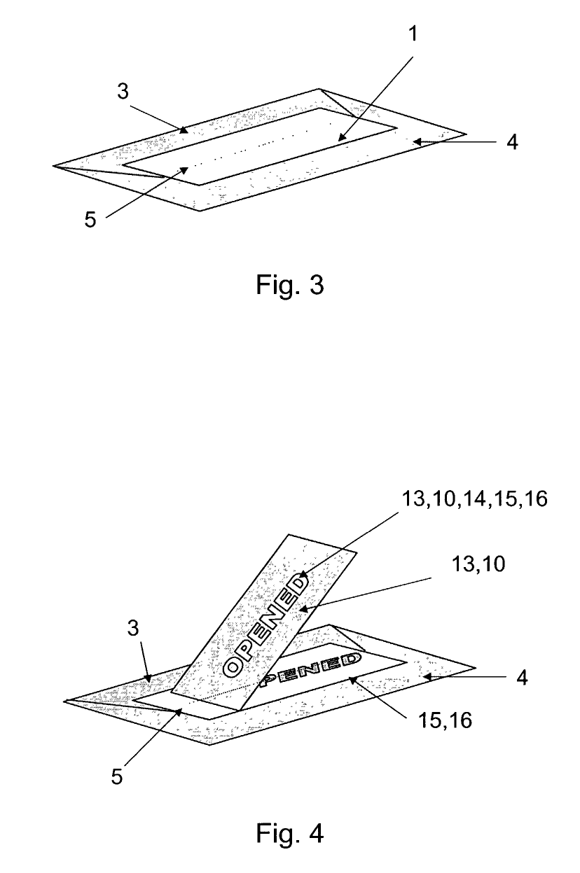

If the adhesive tape 1, with a structure as shown in FIG. 1, is bonded as shown in FIG. 3 on a surface, the preferred transparency of the release layer 13 and of the film backing 10 and also of the primer layer 14 means that the uniform color of the ink layer 15 is visible and, where appropriate, the ink layer 17 showing through the adhesive layer 16.

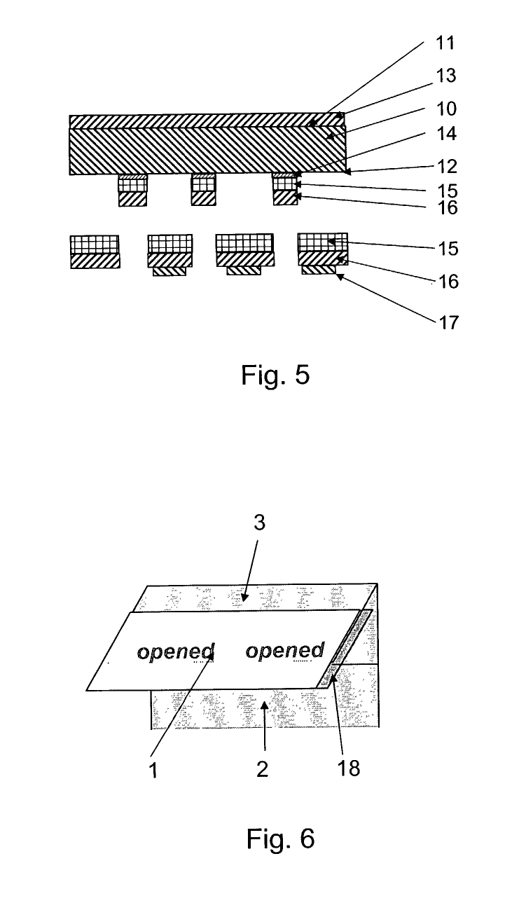

When the adhesive tape 1—as shown in FIG. 4—is detached from the dispatch packet surface, the adhesive tape 1 separates in accordance with FIG. 5. The release layer 15 separates off from the film 10 in the region at which it is in direct contact with the film surface 12, and remains on the packet surface 4. In the region where there is the primer layer 14, the adhesive layer 16 separates from the packet surface 4 and remains on the backing film 10. The word “OPENED” is visible as writing on the packet surface 4 and as direct colored writing on the backing 10.

When the detached portion of the adhesive tape is replaced, the writing “OPENED” remains visible, since owing to the air layer at the interface between release layer 15 and film surface 12 it induces an altered light refraction relative to the interface of the primer layer 14 and film surface 12, and so forms an optical contrast.

Furthermore, owing to the fact that the backing 10 has deformed during application and detachment, the writing on the backing film 10 can no longer be inserted congruently in the exposed writing on the packet surface.

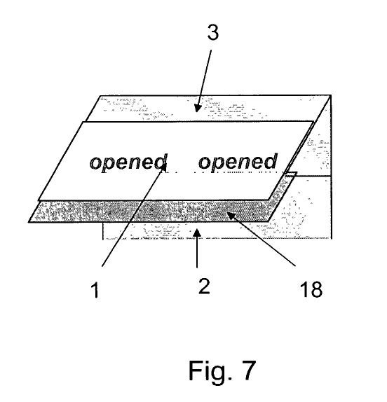

FIGS. 6 and 7 illustrate possibilities in the context of the inventive use of the adhesive tape for covering the adhesive layer 16 of the adhesive tape 1 applied overhangingly on the closure flap 3 with a release liner 18 in order to prevent automatic sealing of the dispatch packet 2.

FIG. 6 shows the case of lining with a release liner 18 in a position which is not offset in relation to the adhesive tape 1. This results in an overlap of the release liner 18 with the closure flap 3 on its lower face.

FIG. 7 represents the case of lining with a release liner 18 when the position is offset with respect to the adhesive tape 1. As a result, the release liner 18 protrudes beyond the edge of the adhesive tape 1 that has not been adhered to the closure flap 3. For both of the cases shown in FIGS. 6 and 7, the overlap or projection of the release liner 18 results in gripping aids for the user of the dispatch packet.

Likewise possible is the lining of the adhesive tape 1 with the release liner wherein, by an appropriate offset of the release liner 18, both cases of the lining, as described in FIGS. 6 and 7, come about.

The concept of the invention embraces the use of the adhesive tape specified in the claims as a security closure for clearly evidencing an unauthorized opening attempt or actual opening for a large number of valuable and/or sensitive goods. An important field of use in this context is the securement of a wide variety of consumer goods against theft, falsification of the contents, and protection against pirate copies. The unnoticed opening, theft and falsification of sensitive goods is prevented by the use of the adhesive tape specified in the claims.

Owing to the ready internal separation of the adhesive tape specified in the claims over its full area when the adhesive tape is removed, its use is particularly suitable for the securement against opening and/or packaging of the dispatch packets, pouches, envelopes, bags, and the like, made, for example, of polyethylene or readily splittable cardboard packaging forms.

The intention of the text below is to illustrate the invention with reference to an example, without wishing to restrict the invention unnecessarily.

### EXAMPLE

a: Film a

A biaxially oriented, coextruded film based on polypropylene from the company Siliconature is used.

| | |
|---|---|
| Film thickness: | 28 μm |
| Identification: | Radil T |
| Company/manufacturer: | Radici |
| Elongation at break, MD: | 130% |
| Elongation at break, CD: | 50% |
| Modulus of elasticity, MD: | 2500 N/mm² |
| Modulus of elasticity, CD: | 4000 N/mm² |

The surface of the film which is coated with a primer layer and with a release layer is corona treated prior to coating with adhesive. The surface energy is >42 mN/m.

b: Adhesives, Primer Layer, Release Layers, and Release Liner Used

b1: Release Coating

A release varnish based on a standard 100% silicone system (UV-curing) is used to produce the adhesive tapes of the invention.

b2: Primer Layer

A primer layer based on an aqueous polyurethane dispersion is used to produce the adhesive tapes of the invention.

Name: NeoRez R560 from Zeneca resins, the Netherlands

b3: Release Layer

A release layer based on a solventborne printing ink is used to produce the adhesive tapes of the invention.

Name: 15VAA Printing Ink from Michael Huber München GmbH, Germany

b4: Adhesive Composition

An adhesive based on an aqueous acrylate dispersion is used to produce the adhesive tapes of the invention.

Name: Primal PS83D from Rohm & Haas, Germany

b5: Release Liner

A release paper based on a 100% silicone system is used.

Name: KS 900 yellow 52B/52B 8 from Laufenberg, Germany

c: Production of the Adhesive Tapes

c1: Application of the Release Coating

The film a is coated with a standard silicone-based release coating by means of the standard technology customary for this purpose.

c2: Coating of the Primer Layer

The film c1 is coated with a primer layer by means of flexographic printing. A flexographic printing plate is used whose raised parts reproduce the word “OPENED”.

The laboratory flexographic printing plate and the web speed are set so that after drying the mass application rate of the primer layer is from about 1 to 3 g/m². Coating takes place on a laboratory coating unit with a working width of 500 mm, at a coating rate of 10 m/min. Downstream of the coating station with wire-wound coater bar applicator unit there is a drying tunnel which is operated with hot air (at approximately 100° C.). The coated film was used immediately without a storage period.

c3: Coating of the Release Layer

The film c2 is coated with the release layer by means of a wire-wound coater bar. The coater bar and the coating rate are adjusted so that after drying of the coated film a mass application rate of the release layer of approximately 25 g/m² is measured. Coating takes place on a pilot-scale coating unit with a working width of 500 mm, at a coating rate of 10 m/min. Downstream of the coating station there is a drying tunnel which is operated with hot air (at approximately 100° C.). The coated film is used immediately without storage.

c4: Coating of the Adhesive

The film c3 is coated with the adhesive by means of a wire-wound coater bar. The coater bar and the coating rate are adjusted so that after drying of the coated film a mass application rate of approximately 25 g/m² is measured. Coating takes place on a pilot-scale coating unit with a working width of 500 mm, at a coating rate of 10 m/min. Downstream of the coating station with wire-wound coater bar applicator unit there is a drying tunnel which is operated with hot air (at approximately 100° C.).

c5: Lining with Release Liner

The web of adhesive in bale form is dried and then lined with the release liner in a laminating unit.

c6: Conversion

The coated film was converted into a width of 25 mm.

d: Results

To determine the mass application, a circular sample of known area is cut from the coated film and weighed. The adhesive composition is then removed by detachment with acetone and the film, now free of adhesive composition, is reweighed. The mass application in g/m² is calculated from the difference.

In order to determine the security effect, the adhesive tapes produced in accordance with the example were investigated. To characterize the security effect on dispatch packets, adhesive strips of the adhesive tapes were bonded to the closure flap, adhering both to the flap and to the packet surface, and pressed on using a steel roller weighing 2 kg (which is rolled twice over the bond). The adhesive strip was peeled off by hand, immediately and after a waiting time of 24 hours at 23° C.

| | Polyethylene | Cardboard dispatch |
|---|---|---|
| Bond to | dispatch packet | packet |
| Printing | yes | yes |
| Surface | printed | printed |
| Letter transfer | very good | very good |
| Distinct security effect | yes | yes |
| Concealed opening of | not possible | not possible |
| the packet at the flap | | |
| Packaging security | very good | very good |

What is claimed is:

1. A method of sealing dispatch packages which comprises of applying to the dispatch package a multilayer adhesive tape with an upper surface, lower surface and a backing based on an oriented thermoplastic film between the upper surface and lower surface, wherein the lower surface comprises of at least the following layers:
a) a primer layer which is not applied over the full area of the thermoplastic film and which anchors to the thermoplastic film,
b) a release layer which is applied over the full area of the applied primer layer and the free thermoplastic film surface, the release layer anchoring better to the primer layer than to the thermoplastic film,
c) a pressure-sensitive adhesive composition which is applied over the full area of the release layer and which is anchored better on the release layer than the release layer is on the thermoplastic film,
wherein upon removal of the multiplayer adhesive tape from the surface of the dispatch package, a layer with inverted writing is left behind on the surface of the dispatch package.

2. The method of claim 1, wherein the dispatch package is selected from the group consisting of pouches, envelopes, packets and bags.

3. The method of claim 1, wherein the primer layer is arranged on the lower film surface so that it produces writing which is visible on the dispatch packet surface if the upper surface and the backing is removed.

4. The method of claim 1, wherein the thermoplastic film comprises oriented polyolefin or polyester.

5. The method of claim 4, wherein the oriented polyolefin or polyester is transparent.

6. The method of claim 4, wherein the thermoplastic film is selected from the group consisting of oriented HDPE, PVC, PET, monoaxially oriented polypropylene and biaxially oriented polypropylene.

7. The method of claim 6, wherein the thermoplastic film is biaxially oriented polypropylene.

8. The method of claim 1, wherein the adhesion of the primer layer to the thermoplastic film and of further layers to one another is improved by means of corona treatment or flame treatment.

9. The method of claim 1, wherein the release layer is selected from the group consisting of resin dispersions, acrylate dispersions, polymer dispersions, water-based flexographic printing inks, solvent-based flexographic printing inks and UV-curing flexographic printing inks.

10. The method of claim 1, wherein the release layer is selected from the group consisting of water-based flexographic printing inks, solvent-based flexographic printing inks and UV-curing flexographic printing inks.

11. The method of claim 1, wherein the adhesive composition is based on an aqueous acrylate dispersion.

12. The method of claim 1, wherein the adhesive tape has been individualized by printing with inks on the adhesive side of the adhesive tape.

13. The method of claim 1, wherein the upper surface of the adhesive tape is optionally coated with a release coating.

14. The method of claim 1, wherein the printing of writing or a symbol has been applied to the outer surface of the adhesive layer.

15. The method of claim 1, wherein the outer surface of the adhesive layer has been lined partially or over its full area with a release liner.

16. The method of claim 7, wherein the thermoplastic film is a biaxially oriented polypropylene with a draw ratio in the longitudinal direction of between 1:4 and 1:9 and a draw ratio in the transverse direction of between 1:4 and 1:9.

17. The method of claim 16, wherein the draw ratio in the longitudinal direction of between 1:4.8 and 1:6 and a draw ratio in the transverse direction of between 1:4.8 and 1:8.5.

18. The method of claim 7, wherein the modulus of elasticity of the adhesive tape in the longitudinal direction is between 1000 and 4000 N/mm².

19. The method of claim 18, wherein the modulus of elasticity of the adhesive tape in the longitudinal direction is between 1500 and 3000 N/mm².

20. The method of claim 7, wherein the thickness of the biaxially oriented films based on polypropylene is between 15 and 100 μm.

21. The method of claim 20, wherein the thickness of the biaxially oriented films based on polypropylene is between 20 and 50 μm.
